(19) United States
(12) Patent Application Publication
(10) Pub. No.: US 2026/0032565 A1
(43) Pub. Date: Jan. 29, 2026

(54) MOBILITY CONFIGURATION ASSOCIATED WITH ON-DEMAND SYSTEM INFORMATION BLOCK CELL DEPLOYMENTS

(71) Applicant: QUALCOMM Incorporated, San Diego, CA (US)

(72) Inventors: Jae Ho RYU, San Diego, CA (US); Qing LI, Princeton Junction, NJ (US); Hung Dinh LY, San Diego, CA (US); Navid ABEDINI, Basking Ridge, NJ (US); Jianghong LUO, Skillman, NJ (US)

(21) Appl. No.: 19/254,841

(22) Filed: Jun. 30, 2025

Related U.S. Application Data
(60) Provisional application No. 63/675,426, filed on Jul. 25, 2024.

(51) Int. Cl. H04W 48/14; H04W 36/08

(52) U.S. Cl. CPC H04W 48/14; H04W 36/08

(57) ABSTRACT

Methods, systems, and devices for wireless communications are described. For example, a user equipment (UE) may receive, via a first cell, control signaling indicative of whether a set of one or more second cells configured for on-demand system information block transmissions is to be evaluated by the UE in association with a cell-reselection procedure. The UE may perform the cell-reselection procedure associated with a second cell of the set of one or more second cells, or a third cell configured for periodic system information block transmissions in accordance with the control signaling.

### CROSS REFERENCES

The present application for patent claims benefit of U.S. Provisional Patent Application No. 63/675,426 by RYU et al., entitled “MOBILITY CONFIGURATION ASSOCIATED WITH ON-DEMAND SYSTEM INFORMATION BLOCK CELL DEPLOYMENTS” and filed Jul. 25, 2024, which is assigned to the assignee hereof and expressly incorporated herein.

### FIELD OF TECHNOLOGY

The following relates to wireless communications, including mobility configuration associated with on-demand system information block cell deployments.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

UEs of the wireless communications systems may leverage periodic or scheduled signaling with cells supported by the wireless communications system. In some examples, the UEs use such signaling to synchronize with cells of the network. Additionally, network entities supporting cells may implement techniques for network energy savings.

### SUMMARY

The systems, methods, and devices of this disclosure each have several innovative aspects, no single one of which is solely responsible for the desirable attributes disclosed herein. Some wireless communications systems may support on-demand system information block type-1 (SIB1) transmissions, which may support network energy savings (NES). Network entities may periodically transmit SIB1 messages that allow a user equipment (UE) to discover, synchronize with, and communicate with a cell. However, the periodic transmissions may be associated with resource (e.g., power) overhead, especially when the cell is a low-traffic environment. An on-demand SIB1 transmission allows a UE to “request” a SIB1 transmission via a wake-up signal (WUS), when the UE selects the cell that supports on-demand SIB1 transmission (hereinafter referred to as an “on-demand SIB1 cell”) in accordance with a cell selection or reselection procedure. As these transmissions are on-demand, the overhead associated with the periodic SIB1 transmissions may be reduced.

However, some types of UEs may not support or be capable of operating with the on-demand SIB1 cells. As such, if this type of UE detects the on-demand SIB1 cell, the UE may not be capable of synchronizing with or communicating with the cell. Thus, the UEs may waste resources when detecting or measuring such cells in accordance with a cell-reselection procedure. Prevention of detection of or measuring on-demand SIB1 cells may support reduction of overhead at UEs that do not support communication with on-demand SIB1 cells. Additionally, as some wireless communications system deployment scenarios may include both on-demand SIB1 cells and cells configured for periodic SIB1 transmission, it may be desirable to prioritize one type of cell over the other.

Techniques described herein support preventing some types of UEs from communicating with on-demand SIB1 cells as well as signaling to configure other types of UEs to utilize on-demand SIB1 cells. To prevent UEs from communicating with on-demand SIB1 cells, control signaling may include the on-demand SIB1 cells in an excluded cell list signaled to the UE, or a reserved value for some parameters may be used to signal the on-demand SIB1 cells. Alternatively, the on-demand SIB1 cells may be identifiable via a new sync raster, which may prevent the legacy UEs from searching or identifying the on-demand SIB1 cells. Additionally, techniques described herein support signaling to identify the on-demand SIB1 cells. In some examples, mobility parameters (e.g., thresholds) that are signaled to the UE may be used for reselection in the legacy cells and the on-demand SIB1 cells. Additionally, or alternatively, signaling may be used to configure the UEs with separate mobility parameters to use for evaluation of the on-demand SIB1 cells. These different parameters may be used to prioritize either the on-demand SIB1 cells or the legacy cells. Thus, the described techniques may support implementation of on-demand SIB1 cells (for network energy saving) while limiting impacts of operations of these cells with UEs that may or may not support communications with such cells.

A method for wireless communications by a user equipment (UE) is described. The method may include receiving, via a first cell, control signaling indicative of whether a set of one or more second cells configured for on-demand system information block transmissions is to be evaluated by the UE in association with a cell-reselection procedure and performing the cell reselection procedure associated with a second cell of the set of one or more second cells, or a third cell configured for periodic system information block transmissions in accordance with the control signaling.

A UE for wireless communications is described. The UE may include one or more memories storing processor executable code, and one or more processors coupled with the one or more memories. The one or more processors may individually or collectively be operable to execute the code to cause the UE to receive, via a first cell, control signaling indicative of whether a set of one or more second cells configured for on-demand system information block transmissions is to be evaluated by the UE in association with a cell-reselection procedure and perform the cell reselection procedure associated with a second cell of the set of one or more second cells, or a third cell configured for periodic system information block transmissions in accordance with the control signaling.

Another UE for wireless communications is described. The UE may include means for receiving, via a first cell, control signaling indicative of whether a set of one or more second cells configured for on-demand system information block transmissions is to be evaluated by the UE in association with a cell-reselection procedure and means for performing the cell reselection procedure associated with a second cell of the set of one or more second cells, or a third cell configured for periodic system information block transmissions in accordance with the control signaling.

A non-transitory computer-readable medium storing code for wireless communications is described. The code may include instructions executable by one or more processors to receive, via a first cell, control signaling indicative of whether a set of one or more second cells configured for on-demand system information block transmissions is to be evaluated by the UE in association with a cell-reselection procedure and perform the cell reselection procedure associated with a second cell of the set of one or more second cells, or a third cell configured for periodic system information block transmissions in accordance with the control signaling.

In some examples of the method, user equipment (UEs), and non-transitory computer-readable medium described herein, the control signaling includes one or more indications that the set of one or more second cells configured for the on-demand system information block transmissions may be unavailable for the cell-reselection procedure.

In some examples of the method, user equipment (UEs), and non-transitory computer-readable medium described herein, the one or more indications include an invalid value for one or more parameters and the invalid value may be indicative of the set of one or more second cells being unavailable.

In some examples of the method, user equipment (UEs), and non-transitory computer-readable medium described herein, the one or more indications include an excluded cell list that may be indicative of the set of one or more second cells being unavailable for the cell-reselection procedure.

In some examples of the method, user equipment (UEs), and non-transitory computer-readable medium described herein, the control signaling may be indicative of a set of mobility parameters to be used for the cell-reselection procedure and the method, apparatuses, and non-transitory computer-readable medium may include further operations, features, means, or instructions for evaluating, in accordance with the set of one or more second cells configured for the on-demand system information block transmissions being unavailable for the cell-reselection procedure and using the set of mobility parameters, the first cell or the third cell configured for the periodic system information block transmissions.

In some examples of the method, user equipment (UEs), and non-transitory computer-readable medium described herein, the control signaling includes one or more indications that the set of one or more second cells configured for the on-demand system information block transmissions may be available for the cell-reselection procedure.

In some examples of the method, user equipment (UEs), and non-transitory computer-readable medium described herein, the one or more indications include an excluded cell list that may be indicative of the set of one or more second cells being available for the cell-reselection procedure.

In some examples of the method, user equipment (UEs), and non-transitory computer-readable medium described herein, the set of one or more second cells in in the excluded cell list may be indicated as being available in accordance with a flag value associated with the excluded cell list.

In some examples of the method, user equipment (UEs), and non-transitory computer-readable medium described herein, the one or more indications include an on-demand system information block type 1 (SIB1) cell list including the set of one or more second cells configured for the on-demand system information block transmissions.

In some examples of the method, user equipment (UEs), and non-transitory computer-readable medium described herein, the control signaling may be indicative of a first set of mobility parameters to be used for the cell-reselection procedure and the method, apparatuses, and non-transitory computer-readable medium may include further operations, features, means, or instructions for evaluating for the cell-reselection procedure, in accordance with the set of one or more second cells configured for the on-demand system information block transmissions being available for the cell-reselection procedure and using the first set of mobility parameters, the set of one or more second cells configured for the on-demand system information block transmissions.

In some examples of the method, user equipment (UEs), and non-transitory computer-readable medium described herein, the control signaling may be indicative of a first set of mobility parameters to be used for the cell-reselection procedure and the method, apparatuses, and non-transitory computer-readable medium may include further operations, features, means, or instructions for evaluating, for the cell-reselection procedure and using the first set of mobility parameters, the first cell, one or more second cells of the set of one or more second cells configured for the on-demand system information block transmissions, the third cell configured for the periodic system information block transmissions, or any combination thereof.

In some examples of the method, user equipment (UEs), and non-transitory computer-readable medium described herein, the control signaling may be indicative of a first set of mobility parameters to be used in evaluating the set of one or more second cells in association with the cell-reselection procedure and a second set of mobility parameters to be used in evaluating the third cell in association with the cell-reselection procedure.

In some examples of the method, user equipment (UEs), and non-transitory computer-readable medium described herein, performing the cell reselection procedure in accordance with the control signaling may include operations, features, means, or instructions for evaluating for the cell-reselection procedure, using the first set of mobility parameters, one or more second cells of the set of one or more second cells configured for the on-demand system information block transmissions and evaluating for the cell-reselection procedure, using the second set of mobility parameters, the third cell configured for the periodic system information block transmissions.

In some examples of the method, user equipment (UEs), and non-transitory computer-readable medium described herein, the first set of mobility parameters to be used in evaluating the set of one or more second cells includes a first priority for a second cell of the set of one or more second cells, one or more first thresholds for the cell-reselection procedure, or a first combination thereof and the second set of mobility parameters to be used in evaluating the third cell includes a second priority for the third cell, one or more second thresholds for the cell-reselection procedure, or a second combination thereof.

Some examples of the method, user equipment (UEs), and non-transitory computer-readable medium described herein may further include operations, features, means, or instructions for identifying, using a first synchronization raster associated with cells configured for the periodic system information block transmissions, one or more cells including the third cell configured for the periodic system information block transmissions and identifying, using a second synchronization raster associated with cells configured for the on-demand system information block transmissions, the set of one or more second cells configured for the on-demand system information block transmissions.

In some examples of the method, user equipment (UEs), and non-transitory computer-readable medium described herein, the first cell may be configured for the on-demand system information block transmissions.

In some examples of the method, user equipment (UEs), and non-transitory computer-readable medium described herein, the first cell may be an anchor cell for the set of one or more second cells, the third cell, or any combination thereof.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports mobility configuration associated with on-demand system information block cell deployments in accordance with one or more aspects of the present disclosure.

FIG. 2 shows an example of a wireless communications system that supports mobility configuration associated with on-demand system information block cell deployments in accordance with one or more aspects of the present disclosure.

FIG. 3 shows an example of a process flow that supports mobility configuration associated with on-demand system information block cell deployments in accordance with one or more aspects of the present disclosure.

FIGS. 4 and 5 show block diagrams of devices that support mobility configuration associated with on-demand system information block cell deployments in accordance with one or more aspects of the present disclosure.

FIG. 6 shows a block diagram of a communications manager that supports mobility configuration associated with on-demand system information block cell deployments in accordance with one or more aspects of the present disclosure.

FIG. 7 shows a diagram of a system including a device that supports mobility configuration associated with on-demand system information block cell deployments in accordance with one or more aspects of the present disclosure.

FIGS. 8 through 10 show flowcharts illustrating methods that support mobility configuration associated with on-demand system information block cell deployments in accordance with one or more aspects of the present disclosure.

### DETAILED DESCRIPTION

Some wireless communications systems may support on-demand system information block type-1 (SIB1) transmissions, which may support network energy savings (NES). Network entities may periodically transmit SIB1 messages that allow a user equipment (UE) to discover, synchronize with, and communicate with a cell. However, the periodic transmissions may be associated with resource (e.g., power) overhead, especially when the cell is a low-traffic environment. An on-demand SIB1 transmission allows a UE to “request” a SIB1 transmission via a wake-up signal (WUS), when the UE selects the cell that supports on-demand SIB1 transmission (hereinafter referred to as an “on-demand SIB1 cell”) in accordance with a cell selection or reselection procedure. As these transmissions are on-demand, the overhead associated with the periodic SIB1 transmissions may be reduced.

However, some types of UEs may not support or be capable of operating with the on-demand SIB1 cells. As such, if this type of UE detects the on-demand SIB1 cell, the UE may not be capable of synchronizing with or communicating with the cell. Thus, the UEs may waste resources when detecting or measuring such cells in accordance with a cell-reselection procedure. Prevention of detection of or measuring on-demand SIB1 cells may support reduction of overhead at UEs that do not support communication with on-demand SIB1 cells. Additionally, as some wireless communications system deployment scenarios may include both on-demand SIB1 cells and cells configured for periodic SIB1 transmission, it may be desirable to prioritize one type of cell over the other.

Techniques described herein support preventing some types of UEs from communicating with on-demand SIB1 cells as well as signaling to configure other types of UEs to utilize on-demand SIB1 cells. To prevent UEs from communicating with on-demand SIB1 cells, control signaling may include the on-demand SIB1 cells in an excluded cell list signaled to the UE, or a reserved value for some parameters may be used to signal the on-demand SIB1 cells. Alternatively, the on-demand SIB1 cells may be identifiable via a new sync raster, which may prevent the legacy UEs from searching or identifying the on-demand SIB1 cells. Additionally, techniques described herein support signaling to identify the on-demand SIB1 cells. In some cases, mobility parameters (e.g., thresholds) that are signaled to the UE may be used for reselection in the legacy cells and the on-demand SIB1 cells. Additionally, or alternatively, signaling may be used to configure the UEs with separate mobility parameters to use for evaluation of the on-demand SIB1 cells. These different parameters may be used to prioritize either the on-demand SIB1 cells or the legacy cells. Thus, the described techniques may support implementation of on-demand SIB1 cells (for network energy saving) while limiting impacts of operations of these cells with UEs that may or may not support communications with such cells. These and other techniques are described in further detail with respect to the figures.

Aspects of the disclosure are initially described in the context of wireless communications systems. Aspects of the disclosure are further described with respect to a wireless communications system implementing both on-demand SIB1 cells and non-on-demand SIB1 cells and a process flow illustrating example signaling. Aspects of the disclosure are further illustrated by and described with reference to apparatus diagrams, system diagrams, and flowcharts that relate to mobility configuration associated with on-demand system information block cell deployments.

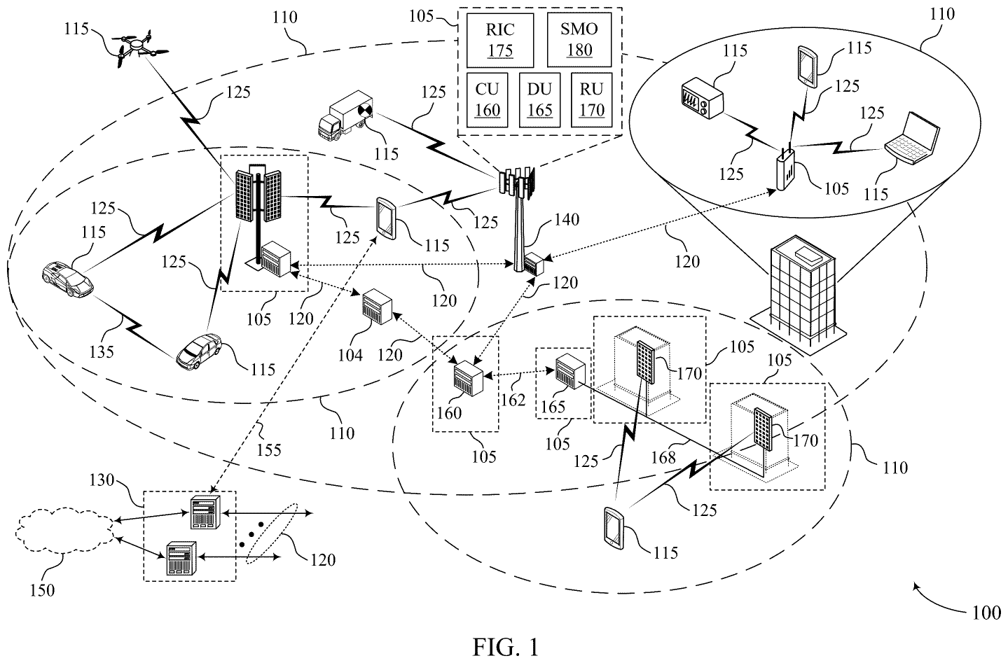

FIG. 1 shows an example of a wireless communications system 100 that supports mobility configuration associated with on-demand system information block cell deployments in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (NB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may support on-demand SIB1 transmission, which may result in NES at network devices (e.g., network entities 105). In some cases, network entities 105 periodically transmit SIB1 messages that allow a UE 115 to discover, synchronize with, and communicate with a cell. However, the periodic transmissions may be associated with resource (e.g., power) overhead, especially when the cell is a low-traffic environment. An on-demand SIB1 transmission allows a UE 115 to “request” a SIB1 transmission via a wake-up signal (WUS) in accordance with a cell selection or reselection procedure. As these transmissions are on-demand, the overhead associated with the periodic SIB1 transmissions may be reduced.

However, some types of UEs 115 may not support or be capable of operating with the on-demand SIB1 cells. As such, if this type of UE 115 detects the on-demand SIB1 cell, the UE 115 may not be capable of synchronizing with or communicating with the cell. Thus, such UEs 115 may waste resources when detecting or measuring such cells in accordance with a cell-reselection procedure. Prevention of detection of or measuring on-demand SIB1 cells may support reduction of overhead at the UEs 115 that do not support communication with on-demand SIB1 cells. Additionally, as some wireless communications system deployment scenarios may include both on-demand SIB1 cells and cells configured for periodic SIB1 transmission (e.g., overlapping and/or neighboring cells), it may be desirable to prioritize one type of cell over the other.

Techniques described herein support preventing some types of UEs 115 from communicating with on-demand SIB1 cells as well as signaling to configure other types of UEs 115 to utilize on-demand SIB1 cells. To prevent the first type of UEs 115 from communicating with on-demand SIB1 cells, control signaling may include the on-demand SIB1 cells in an excluded cell list signaled to the UE 115, or a reserved value for some parameters may be used to signal the on-demand SIB1 cells. Alternatively, the on-demand SIB1 cells may be identifiable via a new synchronization raster, which may prevent the UEs 115 from searching or identifying the on-demand SIB1 cells. Additionally, techniques described herein support signaling to identify the on-demand SIB1 cells. Mobility parameters (e.g., thresholds) that are signaled to the UE 115 may be used for reselection in the legacy cells and the on-demand SIB1 cells. Additionally, or alternatively, signaling may be used to configure the UEs 115 with separate mobility parameters to use for evaluation of the on-demand SIB1 cells. These different parameters may be used to prioritize either the on-demand SIB1 cells or the legacy cells.

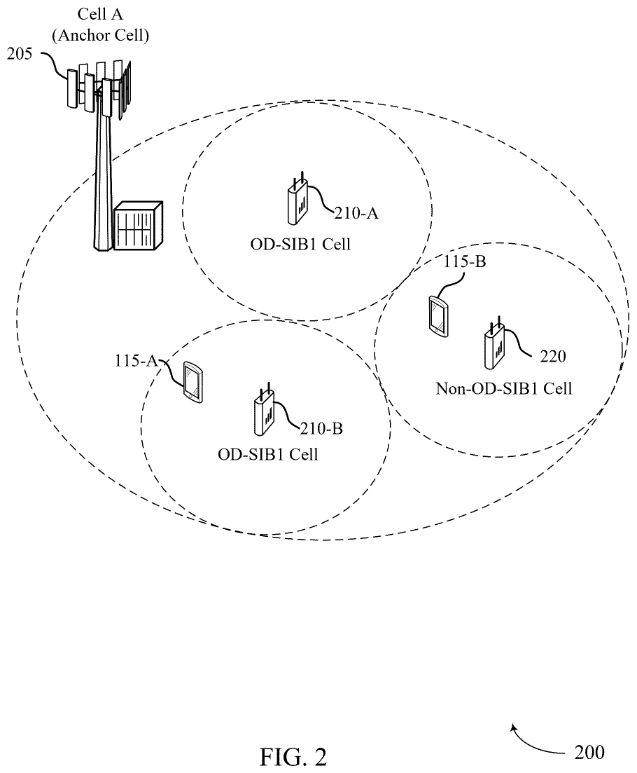

FIG. 2 shows an example of a wireless communications system 200 that supports mobility configuration associated with on-demand system information block cell deployments in accordance with one or more aspects of the present disclosure. The wireless communications system 200 includes an anchor cell 205, on-demand SIB1 (OD-SIB1) cells 210, a non-on-demand SIB1 (non-OD-SIB1) cell 220, UE 115-a, and UE 115-b. Each of the cells (e.g., the anchor cell 205, the on-demand SIB1 cells 210, and the non-on-demand S1B1 cell 220) may be supported by a respective network entity, such as a network entity 105 of FIG. 1.

As described herein, the wireless communication system 200 supports the on-demand SIB1 cells 210 which may be used by UEs 115 in an idle and/or inactive mode. The on-demand SIB1 cells 210 may transmit communications including the SIB1s based on a trigger transmitted by UEs 115, such as a WUS. In such cases, the anchor cell 205 may provide coverage for idle and/or inactive state for UEs 115 that support on-demand SIB1 cells 210 (e.g., Release 19 or Rel-19 UEs) and UEs 115 that do not support communications with on-demand SIB1 cells 210 (e.g., legacy UEs 115). The anchor cell 205 may support an “always-on” SSB/SIB1 transmissions (e.g., periodic SSB/SIB1 transmissions). When on-demand SIB1 cells 210 are overlaid with (e.g., overlapping with) the anchor cell 205, the on-demand SIB1 cells 210 may provide better service than the anchor cell 205 for the UE 115 in a connected state. For example, depending on the UE 115 location, the on-demand SIB1 cell may provide better signal quality than the anchor cell 205. In some cases, the on-demand SIB1 cell 210 supports a larger bandwidth than the anchor cell 205. For example, the on-demand SIB1 cell 210-a is a TDD cell with 100 MHz bandwidth, and the anchor cell is a FDD cell with a 10 MHz bandwidth. The anchor cell 205 may provide, to the UEs 115, configuration information for the on-demand SIB1 procedure for communications with the on-demand SIB1 cell 210. The configuration information may include UL-WUS signal configurations and/or PDCCH/PDSCH configuration for the on-demand SIB1 transmissions by the on-demand SIB1 cells 210. In some cases, because the on-demand SIB1 procedure supports network energy savings (NES), the on-demand SIB1 cells 210 may be referred to as NES cells.

The following Table 1 includes different communications cases for communications with on-demand SIB1 cells:

TABLE 1

| Design | Target cell of UL- | Source cell for UL- | Source cell of OD- |
|---|---|---|---|
| Case | WUS | WUS configuration | SIB1 TX |
| Case1 | NES Cell | NES Cell | NES Cell |
| Case2 | NES Cell | Cell A | NES Cell |
| Case3 | Cell A | Cell A | Cell A |

Case2 and Case3 may be more appropriate than Case1 for the UEs 115 that are operating an idle or inactive mode given that the anchor cell 205 (cell A) may operate with an “always-on” SSB/SIB1 transmission and may provide configuration information for the on-demand SIB1 procedure.

In some cases, the UEs 115 may camp in one or more of the on-demand SIB1 cells 210. The UEs 115 may operate in accordance with an idle/inactive procedure during camping. For example, in a camped cell (e.g., the on-demand SIB1 cell 210-b), the UE 115-a may monitor various channels for cell (re-)selection, monitor channels to (re-)acquire the master information block (MIB) and/or the system information block (SIB), monitor paging resources for system information (SI) updates and downlink data arrival, perform connection setup, and perform location registration or updates. The UE 115-a may also perform, while camped in the on-demand SIB1 cell 210-b, various procedures in neighboring cells, such as monitoring synchronization signal blocks (SSBs) for cell (re-)selection. In some cases, when the UE 115 chooses one of the on-demand SIB1 cell using an intra-frequency or inter-frequency cell-reselection procedure, the UE 115 may trigger the WUS transmission, which may result in transmission of the SIB1 by the on-demand SIB1 cell 210. Additionally, after the UE 115 successfully receives the SIB1 for the NES cell and if the cell is suitable (e.g., based on measurements), then the UE 115 may camp in the NES cell (using procedure similar to a legacy camping procedure). That is, for UEs 115 that support the on-demand SIB1 procedure, the UE 115 behavior may be similar to the procedure defined for legacy UEs in a camped state, such as paging reception, SIB1 updates, etc. After the UE 115 camps in the NES cell, if the UE 115 receives a SIB change notification in paging PDCCH, the UE 115 may be expected to receive the SIB1 from the NES cell. In some cases, the NES cell transmits the updated SIB1 for a specified or configured time in case of a system information (SI) change.

The UEs 115 may operate in accordance with a cell selection/reselection procedure. For example, the UE 115 camps on a cell when the cell selection criterion S is fulfilled. The cell criterion S may be fulfilled when:
Srxlev>0 AND Squal>0, where:

$$\underline{Srxlev} = {Q}_{rxlevmeas} - ( {Q}_{rxlevmin} + {Q}_{rxlevminoffset} ) - {P}_{compensation} - {Qoffset}_{temp} ,$$

$$Squal = {Q}_{qualmeas} - ( {Q}_{qualmin} + {Q}_{qualminoffset} ) - {Qoffset}_{temp} .$$

In the above equations, the following definitions in Table 2 may be applicable:

TABLE 2

| | |
|---|---|
| Srxlev | Cell selection reception (RX) value (dB) |
| Squal | Cell selection quality value (dB) |
| Qoffsetₜₑₘₚ | Offset temporarily applied to a cell |
| Qᵣₓₗₑᵥₘₑₐₛ | Measured cell RX value (RSRP) |
| Q_{qualmeas} | Measured cell quality value (RSRQ) |

Additionally, the P_{compensation} parameter value may be defined as follows:

For frequency-1 (FR1), if the UE supports an additionalPmax in the NR-NS-PmaxList parameters, if present in SIB1, SIB1, and SIB4, then P_{compensation}=max(P_{EMAX1}−P_{powerClass}, 0)−(min(P_{EXMAX2}, P_{PowerClass})−min(P_{EMAX1}, P_{PowerClass})) (dB); else:

$$max ( PEXMAX 1 - PPowerClass , 0 ) ( db ) .$$

For FR2, P_{compensation} is set to 0.
For FR3, P_{compensation} is set to 0.

In some cases, a cellSelectionInfo information element in SIB1 signaling may provide the parameters for S criteria evaluation by the UE 115.

Additionally, the following rules may be used by the UE to limit measurements in accordance with a cell-selection/reselection procedure. Intra-frequency search/measurements may be implemented as follows:

If the serving cell fulfils Srxlev>S_{IntraSearchP} and Squal>S_{IntraSearchQ}, the UE 115 may choose not to perform intra-frequency measurements in accordance with a cell selection/reselection procedure. Otherwise, the UE 115 may perform intra-frequency measurements.

Inter-frequency and/or inter-radio-access technology (inter-RAT) search/measurements may be implemented as follows:

The UE applies the following rules for NR inter-frequencies and inter-RAT frequencies which may be indicated in system information and for which the UE 115 has priority:
For a NR inter-frequency or inter-RAT frequency with a reselection priority higher than the reselection priority of the current NR frequency, the UE shall perform measurements of higher priority NR inter-frequency or inter-RAT frequencies.
For NR inter-frequency with an equal or lower reselection priority than the reselection priority of the current NR frequency and for inter-RAT frequency with lower selection priority than the reselection priority of the current NR frequency:
   If the service cell fulfils Srxlev>S_{IntraSearchP} and Squal>S_{IntraSearchQ}, the UE 115 may choose not to perform measurements of NR inter-frequencies or inter-RAT frequency cells of equal or lower priority;
   Otherwise, the UE may perform measurements of NR inter-frequencies or inter-RAT frequency cells of equal or lower priority.

Moreover, the UEs 115 may implement one or more of the follow procedures and criteria for cell-reselection. For inter-frequency cell-reselection, cell-reselection to a cell on a higher priority inter-frequency or inter-RAT frequency may be performed when the following criteria is satisfied:

A cell of a higher priority RAT/frequency fulfils Srxlev>Thresh_{x,highP} during a time interval Treslection_{RAT}; and
More than 1 second has elapsed since the camped on the current serving cell.

Cell-reselection to a NR cell on an equal priority inter-frequency may be based on ranking for intra-frequency cell-reselection. The cell-ranking criterion Rₛ for serving cell and Rₙ for neighboring cells may be defined by:

$${R}_{s} = {Q}_{meas , s} + {Q}_{hyst} - {Qoffset}_{temp}$$

$${R}_{n} = {Q}_{meas , n} - Qoffset - {Qoffset}_{temp} ,$$

where,
Qₘₑₐₛ is RSRP measurement quantity used in cell-reselections, Qoffsetₜₑₘₚ is the offset temporarily applied toa cell. and Qoffset is defined as follows:
For intra-frequency: equals to Qoffset_{s,n}, if Qoffset_{s,n} is valid, otherwise equals zero.
For inter-frequency: equals to Qoffset_{s,n} plus Qoffset_{frequency}, if Qoffset_{s,n} is valid, otherwise equals to Qoffset_{frequency}.

Cell-reselection to a cell on a lower priority inter-frequency or inter-RAT frequency is performed if:
The serving cells fulfils Srxlev<Thres_{Serving,LowP} and a cell of lower priority RAT/frequency fulfils Srxlev>Thresh_{X,LowP} during a time interval Treselection_{RAT}; and
More than 1 second has elapsed since the UE camped on the current service cell.

In some examples, SIB2 signaling may indicate cell-reselection information and parameters common for intra-frequency and/or inter-frequency/inter-RAT cell-reselection. SIB4 signaling may contain information and/or parameters relevant for inter-frequency cell re-selection. However, signaling may not support idle or inactive mobility configurations of on-demand SIB1 cells 210 for the UEs 115 that support communications in such cells. Additionally, signaling may not prevent or limit the ability of the UEs 115 that do not support communications in on-demand SIB1 cells 210 to search and/or evaluate (e.g., measure) the on-demand SIB1 cells 210 in accordance with a cell reselection procedure.

Techniques described herein support signaling to provide mobility configurations for the UEs 115 that do support communications in the on-demand SIB1 cells 210 such as to provide idle/inactive mode mobility in deployment scenarios that include on-demand SIB cells 210. The described techniques may also limit the ability for UEs 115 that do not support communications in the on-demand SIB1 cells 210 to search, measure, and or evaluate such cells in accordance with cell-reselection procedure. Additionally, the described signaling may be minimally impactful to idle/inactive mode mobility for such UEs 115 (e.g., that do not support communications in on-demand SIB1 cells 210).

Different deployment scenarios may be available when on-demand SIB1 cells 210 are implemented. For example, as illustrated in FIG. 2, a deployment scenario may include anchor cell 205 and a mix of cells that are not configured for or are not currently implementing on-demand SIB1 signaling (e.g., non-on-demand SIB1 cell 220) and on-demand SIB1 cells 210. This scenario may be referred to mixed deployment scenario. Alternatively, a deployment scenario may include the anchor cell 205 and only on-demand SIB1 cells 210 (e.g., no non-on-demand SIB1 cells 220). Other types of scenarios may be available within the context of the present disclosure. The deployment scenarios may impact the signaling and/or behaviors of the UEs 115 operating within the scenario. Additionally, the type of the UE 115 (e.g., whether the UE 115 supports communications in on-demand SIB1 cells) may impact the signaling and/or behavior of the UE 115. The following table 3 provides an overview of signaling and/or behavior of UEs 115 in different deployment scenarios.

TABLE 3

| | Mixed | | Legacy | Separate |
|---|---|---|---|---|
| | OD-SIB1 | | Mobility | Mobility |
| Sync | and legacy | Legacy UE | Control | Control |
| Raster | cell | reselection | Parameters | Parameters |
| Legacy | No | Not allowed | Used for R19 | N/A |
| sync | (OD-SIB1 | | UEs for OD- | |
| raster | cell only) | | SIB1 cells | |
| | Yes | Allowed | Used by | Used for R19 |
| | | (only for | legacy/R19 | UE for OD- |
| | | non-OD-SIB1 | UEs for non- | SIB1 cell |
| | | cell) | OD-SIB1 cell | |
| Non- | No | Not allowed | Used for R19 | N/A |
| legacy | (OD-SIB1 | | UE for OD- | |
| sync | cell only) | | SIB1 cell | |
| raster | Yes | Not allowed | Used for R19 | Used for R19 |
| | | | UE for non- | UE for OD- |
| | | | OD-SIB1 cell | SIB1 cell |

In table 3, “R19” UEs refers to Release 19 (or later) UEs or the UEs 115 that support communications in on-demand SIB1 cells 210. Additionally, as described in further detail herein, a new synchronization raster may be implemented by the R19 UEs in order to identify the on-demand SIB1 cells 210 or both the non-on-demand SIB1 cells 220 and the on-demand SIB1 cells 210, and the legacy UEs (e.g., Release 18 or earlier UEs, or UEs that do not support on-demand SIB1 cell communications) may not implement or utilize such a synchronization raster. Moreover, as described in further detail herein, if separate mobility control parameters are not configured for the different cell types, then the legacy mobility control parameters may be used for both the non-on-demand SIB1 cells 220 and the on-demand SIB1 cells 210.

In an environment where all the cells on a frequency layer are on-demand SIB1 cells 210, to support reduction in a legacy UEs resource overhead, signaling may be used (e.g., by the anchor cell 205) to prevent or limit the ability of the legacy UEs 115 to identify, measure, and/or evaluate the on-demand SIB1 cells 210 in accordance with a cell-reselection procedure. That is, the signaling may be used to prevent the legacy UE from searching for on the frequency layer that includes the on-demand SIB1 cells 210. In some case, signaling similar to the signaling used for a cell with a less than 5 MHz may be used for prevention of legacy UEs for evaluating the on-demand SIB1 cells. That is, one or more of various parameters in signaling may be set to reserved values, which signals to the legacy UEs 115 to not search in those frequency layers. For example, dl-CarrierFreq and frequencyBandList in interFreqCarrierInfo is set to reserved value (ARFCN=250, band=200) to prevent the legacy UEs from searching or evaluating the on-demand SIB1 cells 210. For example, the UE 115 may implement a rule associated with the dl-CarrierFreq parameter that indicates for neighboring carrier frequency when dl-CarrierFreq-r18 is included the network sets the corresponding value of dl-Carrier-Freq (without suffix) to 250, and the UE applies dl-CarrierFreq-r18 instead of dl-CarrierFreq (without suffix). In such cases, the UE does not support the global synchronization carrier number (GSCN) value corresponding to the dl-CarrierFreq-r18, the UE ignores the corresponding neighbor cell. Additionally, the UE 115 may implement a rule associated with the frequencyBandList parameter that indicates that the list of frequency bands for which the NR cell-reselection parameters apply, and for neighboring carrier frequency when frequencBandList-r18 is included, the network sets the corresponding value of frequencyBandIndicatorNR in frequencyBandList (without suffix) to 200, and the UE applies frequencyBandList-r18 instead of frequencyBandList (without suffix). These techniques may be implemented if the on-demand SIB1 cells 210 are identifiable via a new synchronization raster or via the legacy synchronization raster.

Moreover, in the environment where all the cells on a frequency layer are on-demand SIB1 cells 210, the UEs 115 that support communications in the on-demand SIB1 cells may be provided signaling (e.g., by the anchor cell 205) to identity or evaluate the on-demand SIB1 cells 210. For example, separate dl-CarrierFreq and frequencyBandList associated with OD-SIB1 cell may be provided in an information element intended for such UEs 115, such as InterFreqCarrierFreqList-v1900. Additionally, legacy mobility parameters (e.g., mobility parameters configured at both types of the UEs 115) may be used for reselection to (e.g., evaluation of) on-demand SIB1 cells 210 by the UEs 115 that support communication in such cells.

In a deployment scenario that includes a mix of on-demand SIB1 cells 210 and non-on-demand SIB1 cells 220 (e.g., on the frequency), the techniques may depend on whether the legacy synchronization raster or a new synchronization raster supports identification of the on-demand SIB1 cells 210. In cases where the frequency is on the legacy synchronization raster, the legacy UE 115 is allowed to search neighbor cells on the frequency layer (e.g., to evaluate the non-on-demand SIB1 cells 220). That is, after neighbor cell search, it is desirable to allow the legacy UE 115 to continue measurement of the detected cell when the cell is the non-on-demand SIB1 cell 220. The UEs 115 that support communication with on-demand SIB1 cells 210 may be configured with the same or different parameters for idle mode mobility control (e.g., mobility parameters). That is, such UEs 115 may be configured with a first set of mobility parameters for evaluation of the non-on-demand SIB1 cells 220 (e.g., legacy parameters) and a second set of mobility parameters for evaluation of the on-demand SIB1 cells 210. Thus, the legacy UEs 115 may rely on existing parameters to determine when to initiate inter-frequency cell search, such as s-NonIntraSearchP, cellReselectionPriority, threshServingLowP, threshX-HighP, and threshX-LowP. Moreover, the on-demand SIB1 cells may be identified in an excluded cell list parameter (e.g., into interFreqExcludedCellList in InterFreqCarrierFreqInfo) to prevent the legacy UE from measuring the on-demand SIB1 cells 210 for purposes of cell-reselection.

Additionally, the Rel-19 UEs 115 may be provided signaling to identify the on-demand SIB1 cells 210 for cell-reselection. In accordance with a first option for signaling, the cells in cell excluded list (e.g., interFreqExcludedCellList in InterFreqCarrierFreqInfo) may be on-demand SIB1 cells 210, and a flag (e.g., 1-bit) may be included in another parameter (e.g., InterFreqCarrierFreqList-v1900) to indicate that the cells in the excluded cell list are available for reselection for the Rel-19 UEs 115. Thus, in accordance this option, the same excluded cell list may be signaled to both the legacy UEs 115 and the Rel-19 UEs 115. However, the legacy UEs 115 may ignore the cells on the list (e.g., the on-demand SIB1 cells 210), and the flag may indicate to the Rel-19 UEs 115 that the cells are available for reselection. In accordance with another option for signaling, the on-demand SIB1 cells 210 may be separately indicate to the Rel-19 UEs via additional parameters intended for such UEs 115, such as interFreqOD-SIB1CellList in InterFreqCarrierFreqList-v1900.

Additionally, as described herein, separate mobility control parameters may be configured for the Rel-19 UEs 115. For example, separate cellReselectionPriority-OD-SIB1 may be configured in InterFreqCarrierFreqList-v1900. Separate q-RxLevMin-OD-SIB1, q-QualMin-OD-SIB1, and/or Qoffsetfrequency-OD-SIB1 can be configured in InterFreqCarrierFreqList-v1900. Separate t-ReselectionNR-OD-SIB1, threshX-HighP, Q-OD-SIB1, threshX-LowP, and/or Q-OD-SIB may be configured in InterFreqCarrierFreqList-v1900. Separate parameters for OD-SIB1 may be applicable to on-demand-SIB1 cells 210. For non-OD-SIB1 neighbor cell, Rel-19 UE may apply legacy parameters in InterFreqCarrierFreqList. Signaling of separate parameters for on-demand SIB1 cells 210 may be optional. If separate parameters are not provided, the Rel-19 UE 115 may assume that legacy parameters are applied to both on-demand SIB1 neighbor cells and non-on-demand SIB1 neighbor cell for cell-reselection evaluation.

In cases where a deployment scenario has a mix of on-demand SIB1 cells 210 and non-on-demand SIB1 cells 220 (e.g., on a frequency) and a new synchronization raster is utilized, the legacy UEs 115 may not be configured to reselect to cells in the frequency layer since the new synchronization raster may not be indicated via dl-CarrierFreq in interFreqCarrierInfo. Additionally, separate dl-CarrierFreq and frequencyBandList associated with on-demand SIB1 cells 210 may be provided in additional signaling, such as InterFreqCarrierFreqList-v1900. Additionally, legacy mobility control parameters in interFreqCarrierInfo may be used for mobility control to non-on-demand-SIB1 cells 220. Separate mobility control parameters for Rel-19 UE may be optionally configured, as described herein. In such cases, separate mobility control parameters for the on-demand SIB1 cells 210 may be applicable to only on-demand SIB1 neighbor cells. Thus, for non-on-demand-SIB1 neighbor cell, the Rel-19 UE 115 applies legacy parameters in InterFreqCarrierFreqList. As described herein, signaling of separate parameters for on-demand-SIB1 cells 210 may be optional. If separate parameters are not provided, UE assumes that legacy parameters are applied to both on-demand SIB1 neighbor cell and non-on-demand-SIB1 neighbor cells. In some examples, the separate mobility parameters may be used to prioritize one type of cell over another. For example, the network, in order to support selection to an on-demand SIB1 cells 210, may provide different (e.g., lower) thresholds for evaluation of the on-demand SIB1 cells 210 so that the UEs 115 are more likely to reselect to such cells. Similar techniques may be used to prioritize non-on-demand SIB1 cells 220.

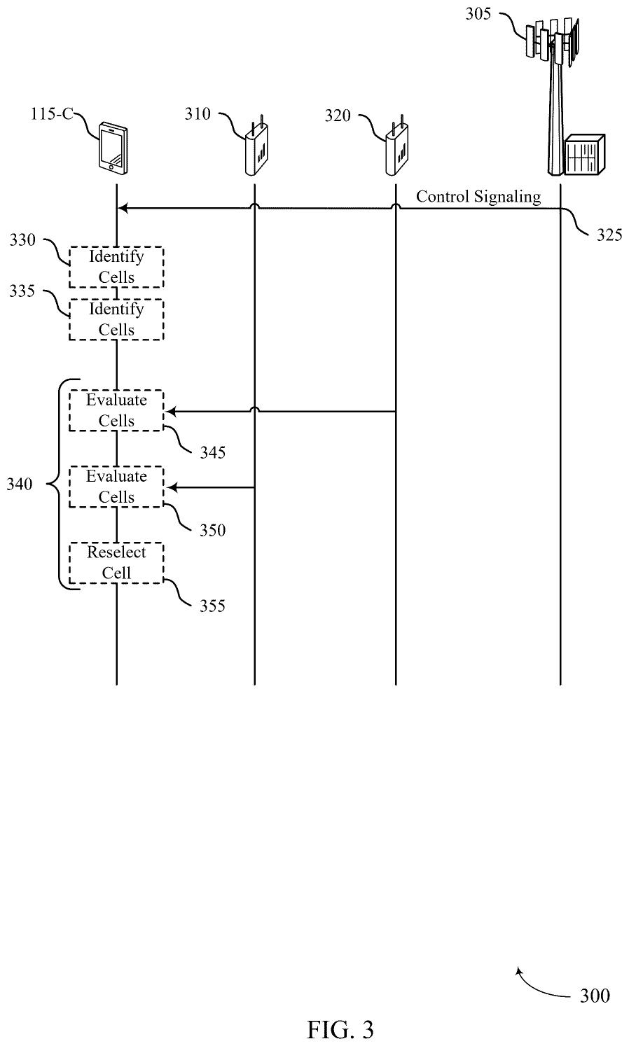

FIG. 3 shows an example of a process flow 300 that supports mobility configuration associated with on-demand system information block cell deployments in accordance with one or more aspects of the present disclosure. The process flow 300 includes a UE 115-c, a first cell 305, one or more second cells 310, and a third cell 320. The one or more second cells 310 may be examples of the on-demand SIB1 cells 210 as described with respect to FIG. 2. The third cell 320 may be an example non-on-demand SIB1 cell 220 as described with respect to FIG. 2. The first cell 305 may be an example of the anchor cell 205 as described with respect to FIG. 2. It should be understood that other deployment scenarios of aspects of the process flow 300 may be implemented within the context of the present disclosure. Alternative examples of the following may be implemented, where some operations are performed in a different order than described or are not performed at all. In some cases, operations may include additional features not mentioned below, or further operations may be added. Although the UE 115-c, the first cell 305, the second cell 310, and the third cell 320 are shown performing the operations of the process flow 300, some aspects of some operations may also be performed by one or more other components or systems.

At 325, the UE 115-c may receive, via the first cell 305, control signaling indicative of whether a set of one or more second cells (e.g., the second cell 310) configured for on-demand system information block transmissions is to be evaluated by the UE in association with a cell-reselection procedure.

At 330, the UE 115-c may identify, using a first synchronization raster associated with cells configured for the periodic system information block transmissions, one or more cells including the third cell 320 configured for the periodic system information block transmissions.

At 335, the UE 115-c may identify, using a second synchronization raster associated with cells configured for the on-demand system information block transmissions, the set of one or more second cells 310 configured for the on-demand system information block transmissions.

At 340, the UE 115-c may perform the cell-reselection procedure associated with the second cell 310 of the set of one or more second cells, or the third cell 320 configured for periodic system information block transmissions in accordance with the control signaling.

In some examples, the control signaling includes one or more indications that the set of one or more second cells configured for the on-demand system information block transmissions (e.g., the second cell 310) is unavailable for the cell-reselection procedure. For example, the one or more indications may include an invalid value for one or more parameters, and the invalid value may be indicative of the set of one or more second cells being unavailable. Additionally or alternatively, the one or more indications may include an excluded cell list that is indicative of the set of one or more second cells being unavailable for the cell-reselection procedure. The one or more second cells may be indicated as unavailable due to the UE 115-c not supporting communications in the on-demand SIB1 cells (e.g., the second cell 310). In some examples, the control signaling may be indicative of a set of mobility parameters to be used for the cell-reselection procedure at 340, and the cell-reselection procedure at 340 may include the UE, at 345, evaluating, in accordance with the set of one or more second cells configured for the on-demand system information block transmissions being unavailable for the cell-reselection procedure and using the set of mobility parameters, the first cell or the third cell configured for the periodic system information block transmissions.

In some examples, the control signaling includes one or more indications that the set of one or more second cells configured for the on-demand system information block transmissions is available for the cell-reselection procedure. In such cases, the one or more indications may include an excluded cell list that is indicative of the set of one or more second cells being available for the cell-reselection procedure. Moreover, the set of one or more second cells in in the excluded cell list may be indicated as being available in accordance with a flag value associated with the excluded cell list. In some examples, the one or more indications include on-demand system information block type 1 (SIB1) cell list comprising the set of one or more second cells configured for the on-demand system information block transmissions.

In some cases, the control signaling is indicative of a first set of mobility parameters to be used for the cell-reselection procedure. In such case, the cell-reselection procedure at 340 may include the UE 115-c, at 350, evaluating in accordance with the set of one or more second cells configured for the on-demand system information block transmissions being available for the cell-reselection procedure and using the first set of mobility parameters, the set of one or more second cells (e.g., the second cell 310) configured for the on-demand system information block transmissions. Additionally, or alternatively, the cell-reselection procedure at 340 may include the UE 115-c, at 345 and 350, evaluating using the first set of mobility parameters, the first cell 305, one or more second cells (e.g., the second cell 310) of the set of one or more second cells configured for the on-demand system information block transmissions, the third cell configured for the periodic system information block transmissions, or any combination thereof.

Additionally, or alternatively, the control signaling is indicative of a first set of mobility parameters to be used in evaluating the set of one or more second cells in association with the cell-reselection procedure and a second set of mobility parameters to be used in evaluating the third cell in association with the cell-reselection procedure. In such cases, the UE 115-c may, at 350, evaluate, using the first set of mobility parameters, one or more second cells (e.g., the second cell 310) of the set of one or more second cells configured for the on-demand system information block transmissions. At 345, the UE 115-c may evaluate, using the second set of mobility parameters, the third cell 320 configured for the periodic system information block transmissions. The first set of mobility parameters to be used in evaluating the set of one or more second cells may include a first priority for the second cell 310 of the set of one or more second cells, one or more first thresholds for the cell-reselection procedure, or a first combination thereof. The second set of mobility parameters to be used in evaluating the third cell 320 may include a second priority for the third cell, one or more second thresholds for the cell-reselection procedure, or a second combination thereof. In some cases, at 355, the UE 115-c may reselect to another cell (e.g., the second cell 310 or the first cell 320) based on the evaluation in accordance with the cell-reselection procedure.

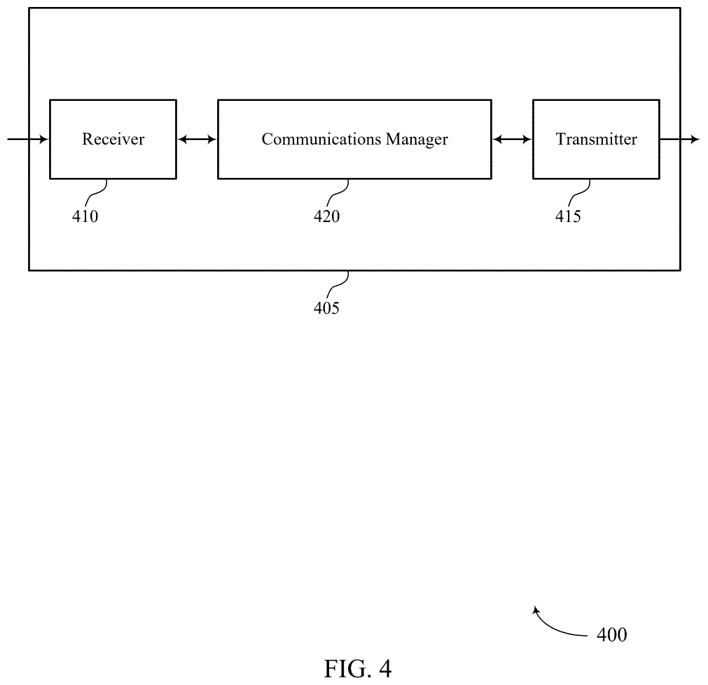

FIG. 4 shows a block diagram 400 of a device 405 that supports mobility configuration associated with on-demand system information block cell deployments in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to mobility configuration associated with on-demand system information block cell deployments). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to mobility configuration associated with on-demand system information block cell deployments). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of mobility configuration associated with on-demand system information block cell deployments as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for receiving, via a first cell, control signaling indicative of whether a set of one or more second cells configured for on-demand system information block transmissions is to be evaluated by the UE in association with a cell-reselection procedure. The communications manager 420 is capable of, configured to, or operable to support a means for performing the cell-reselection procedure associated with a second cell of the set of one or more second cells, or a third cell configured for periodic system information block transmissions in accordance with the control signaling.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for reduced power consumption by UEs (e.g., by supporting improved inactive/idle state mobility control) and reduced energy consumption at the network (e.g., by supporting on-demand SIB1 transmissions).

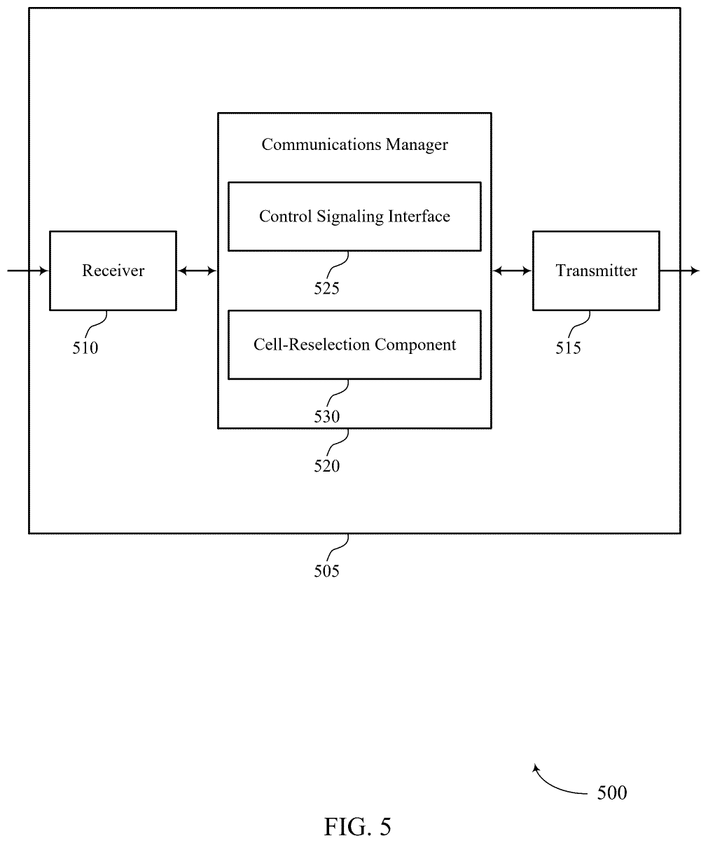

FIG. 5 shows a block diagram 500 of a device 505 that supports mobility configuration associated with on-demand system information block cell deployments in accordance with one or more aspects of the present disclosure. The device 505 may be an example of aspects of a device 405 or a UE 115 as described herein. The device 505 may include a receiver 510, a transmitter 515, and a communications manager 520. The device 505, or one of more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to mobility configuration associated with on-demand system information block cell deployments). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to mobility configuration associated with on-demand system information block cell deployments). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of mobility configuration associated with on-demand system information block cell deployments as described herein. For example, the communications manager 520 may include a control signaling interface 525 a cell-reselection component 530, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The control signaling interface 525 is capable of, configured to, or operable to support a means for receiving, via a first cell, control signaling indicative of whether a set of one or more second cells configured for on-demand system information block transmissions is to be evaluated by the UE in association with a cell-reselection procedure. The cell-reselection component 530 is capable of, configured to, or operable to support a means for performing the cell-reselection procedure associated with a second cell of the set of one or more second cells, or a third cell configured for periodic system information block transmissions in accordance with the control signaling.

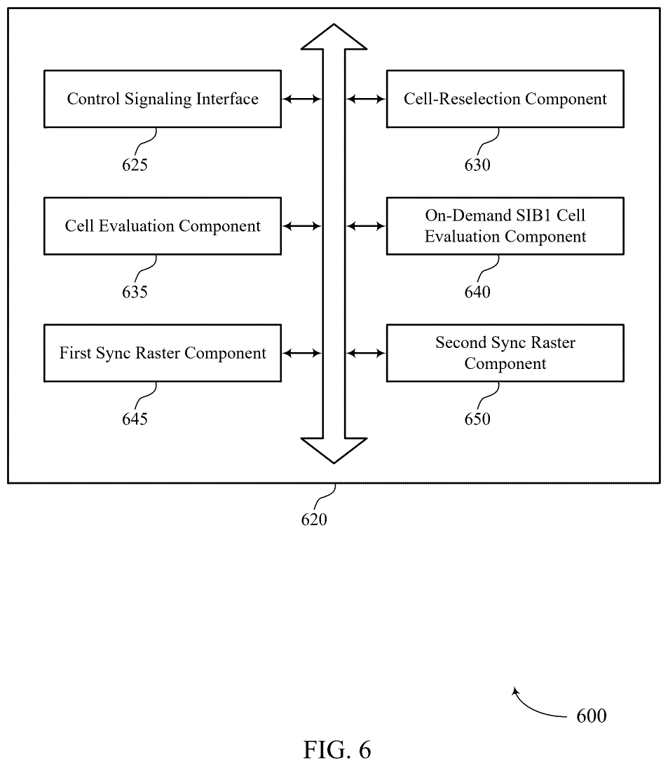

FIG. 6 shows a block diagram 600 of a communications manager 620 that supports mobility configuration associated with on-demand system information block cell deployments in accordance with one or more aspects of the present disclosure. The communications manager 620 may be an example of aspects of a communications manager 420, a communications manager 520, or both, as described herein. The communications manager 620, or various components thereof, may be an example of means for performing various aspects of mobility configuration associated with on-demand system information block cell deployments as described herein. For example, the communications manager 620 may include a control signaling interface 625, a cell-reselection component 630, a cell evaluation component 635, an on-demand SIB1 cell evaluation component 640, a first sync raster component 645, a second sync raster component 650, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The control signaling interface 625 is capable of, configured to, or operable to support a means for receiving, via a first cell, control signaling indicative of whether a set of one or more second cells configured for on-demand system information block transmissions is to be evaluated by the UE in association with a cell-reselection procedure. The cell-reselection component 630 is capable of, configured to, or operable to support a means for performing the cell-reselection procedure associated with a second cell of the set of one or more second cells, or a third cell configured for periodic system information block transmissions in accordance with the control signaling.

In some examples, the control signaling includes one or more indications that the set of one or more second cells configured for the on-demand system information block transmissions is unavailable for the cell-reselection procedure.

In some examples, the one or more indications include an invalid value for one or more parameters. In some examples, the invalid value is indicative of the set of one or more second cells being unavailable.

In some examples, the one or more indications include an excluded cell list that is indicative of the set of one or more second cells being unavailable for the cell-reselection procedure.

In some examples, the control signaling is indicative of a set of mobility parameters to be used for the cell-reselection procedure, and the cell evaluation component 635 is capable of, configured to, or operable to support a means for evaluating, in accordance with the set of one or more second cells configured for the on-demand system information block transmissions being unavailable for the cell-reselection procedure and using the set of mobility parameters, the first cell or the third cell configured for the periodic system information block transmissions.

In some examples, the control signaling includes one or more indications that the set of one or more second cells configured for the on-demand system information block transmissions is available for the cell-reselection procedure.

In some examples, the one or more indications include an excluded cell list that is indicative of the set of one or more second cells being available for the cell-reselection procedure.

In some examples, the set of one or more second cells in in the excluded cell list are indicated as being available in accordance with a flag value associated with the excluded cell list.

In some examples, the one or more indications include an on-demand system information block type 1 (SIB1) cell list including the set of one or more second cells configured for the on-demand system information block transmissions.

In some examples, the control signaling is indicative of a first set of mobility parameters to be used for the cell-reselection procedure, and the on-demand SIB1 cell evaluation component 640 is capable of, configured to, or operable to support a means for evaluating for the cell-reselection procedure, in accordance with the set of one or more second cells configured for the on-demand system information block transmissions being available for the cell-reselection procedure and using the first set of mobility parameters, the set of one or more second cells configured for the on-demand system information block transmissions.

In some examples, the control signaling is indicative of a first set of mobility parameters to be used for the cell-reselection procedure, and the cell evaluation component 635 is capable of, configured to, or operable to support a means for evaluating, for the cell-reselection procedure and using the first set of mobility parameters, the first cell, one or more second cells of the set of one or more second cells configured for the on-demand system information block transmissions, the third cell configured for the periodic system information block transmissions, or any combination thereof.

In some examples, the control signaling is indicative of a first set of mobility parameters to be used in evaluating the set of one or more second cells in association with the cell-reselection procedure and a second set of mobility parameters to be used in evaluating the third cell in association with the cell-reselection procedure.

In some examples, to support performing the cell-reselection procedure in accordance with the control signaling, the on-demand SIB1 cell evaluation component 640 is capable of, configured to, or operable to support a means for evaluating for the cell-reselection procedure, using the first set of mobility parameters, one or more second cells of the set of one or more second cells configured for the on-demand system information block transmissions. In some examples, to support performing the cell-reselection procedure in accordance with the control signaling, the cell evaluation component 635 is capable of, configured to, or operable to support a means for evaluating for the cell-reselection procedure, using the second set of mobility parameters, the third cell configured for the periodic system information block transmissions.

In some examples, the first set of mobility parameters to be used in evaluating the set of one or more second cells includes a first priority for a second cell of the set of one or more second cells, one or more first thresholds for the cell-reselection procedure, or a first combination thereof. In some examples, the second set of mobility parameters to be used in evaluating the third cell includes a second priority for the third cell, one or more second thresholds for the cell-reselection procedure, or a second combination thereof.

In some examples, the first sync raster component 645 is capable of, configured to, or operable to support a means for identifying, using a first synchronization raster associated with cells configured for the periodic system information block transmissions, one or more cells including the third cell configured for the periodic system information block transmissions. In some examples, the second sync raster component 650 is capable of, configured to, or operable to support a means for identifying, using a second synchronization raster associated with cells configured for the on-demand system information block transmissions, the set of one or more second cells configured for the on-demand system information block transmissions.

In some examples, the first cell is configured for the on-demand system information block transmissions.

In some examples, the first cell is an anchor cell for the set of one or more second cells, the third cell, or any combination thereof.

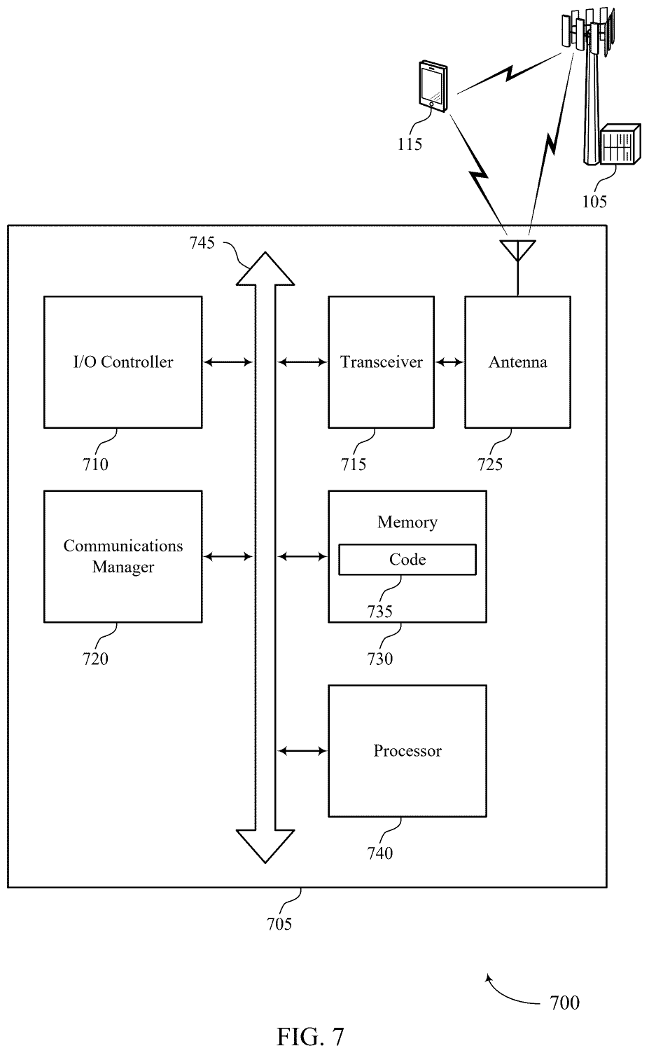

FIG. 7 shows a diagram of a system 700 including a device 705 that supports mobility configuration associated with on-demand system information block cell deployments in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting mobility configuration associated with on-demand system information block cell deployments). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for receiving, via a first cell, control signaling indicative of whether a set of one or more second cells configured for on-demand system information block transmissions is to be evaluated by the UE in association with a cell-reselection procedure. The communications manager 720 is capable of, configured to, or operable to support a means for performing the cell-reselection procedure associated with a second cell of the set of one or more second cells, or a third cell configured for periodic system information block transmissions in accordance with the control signaling.

By including or configuring the communications manager 720 in accordance with examples as described herein, the device 705 may support techniques for reduced power consumption by UEs (e.g., by supporting improved inactive/idle state mobility control) and reduced energy consumption at the network (e.g., by supporting on-demand SIB1 transmissions).

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of mobility configuration associated with on-demand system information block cell deployments as described herein, or the at least one processor 740 and the at least one memory 730 may be otherwise configured to, individually or collectively, perform or support such operations.

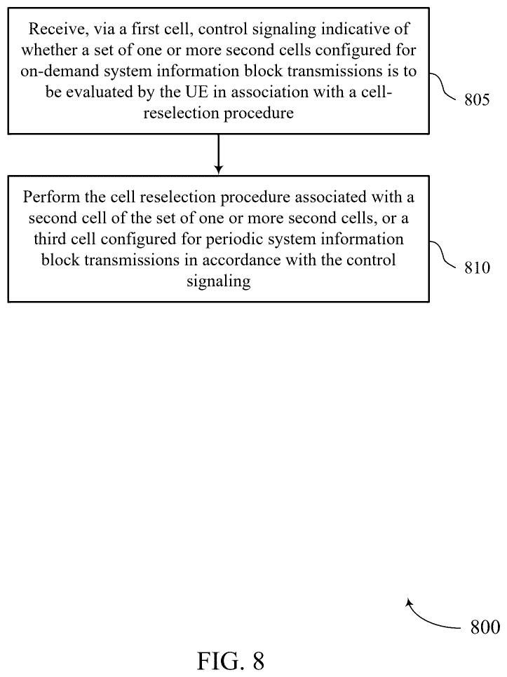

FIG. 8 shows a flowchart illustrating a method 800 that supports mobility configuration associated with on-demand system information block cell deployments in accordance with one or more aspects of the present disclosure. The operations of the method 800 may be implemented by a UE or its components as described herein. For example, the operations of the method 800 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 805, the method may include receiving, via a first cell, control signaling indicative of whether a set of one or more second cells configured for on-demand system information block transmissions is to be evaluated by the UE in association with a cell-reselection procedure. The operations of 805 may be performed in accordance with examples as disclosed herein. In some examples, aspects of the operations of 805 may be performed by a control signaling interface 625 as described with reference to FIG. 6.

At 810, the method may include performing the cell-reselection procedure associated with a second cell of the set of one or more second cells, or a third cell configured for periodic system information block transmissions in accordance with the control signaling. The operations of 810 may be performed in accordance with examples as disclosed herein. In some examples, aspects of the operations of 810 may be performed by a cell-reselection component 630 as described with reference to FIG. 6.

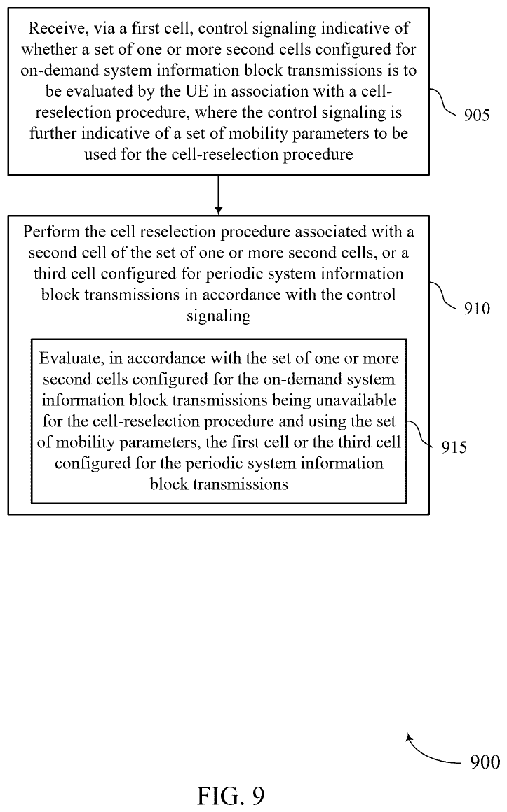

FIG. 9 shows a flowchart illustrating a method 900 that supports mobility configuration associated with on-demand system information block cell deployments in accordance with one or more aspects of the present disclosure. The operations of the method 900 may be implemented by a UE or its components as described herein. For example, the operations of the method 900 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 905, the method may include receiving, via a first cell, control signaling indicative of whether a set of one or more second cells configured for on-demand system information block transmissions is to be evaluated by the UE in association with a cell-reselection procedure, where the control signaling is further indicative of a set of mobility parameters to be used for the cell-reselection procedure. The operations of 905 may be performed in accordance with examples as disclosed herein. In some examples, aspects of the operations of 905 may be performed by a control signaling interface 625 as described with reference to FIG. 6.

At 910, the method may include performing the cell-reselection procedure associated with a second cell of the set of one or more second cells, or a third cell configured for periodic system information block transmissions in accordance with the control signaling. The operations of 910 may be performed in accordance with examples as disclosed herein. In some examples, aspects of the operations of 910 may be performed by a cell-reselection component 630 as described with reference to FIG. 6.

At 915, the method may include evaluating, in accordance with the set of one or more second cells configured for the on-demand system information block transmissions being unavailable for the cell-reselection procedure and using the set of mobility parameters, the first cell or the third cell configured for the periodic system information block transmissions. The operations of 915 may be performed in accordance with examples as disclosed herein. In some examples, aspects of the operations of 915 may be performed by a cell evaluation component 635 as described with reference to FIG. 6.

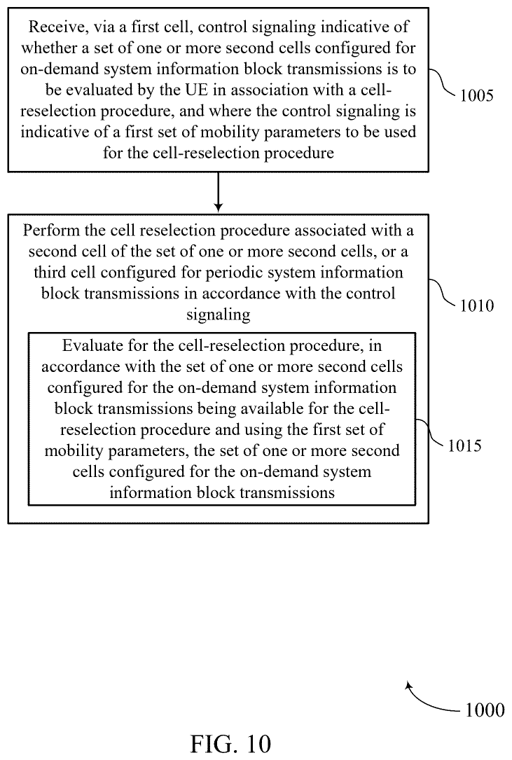

FIG. 10 shows a flowchart illustrating a method 1000 that supports mobility configuration associated with on-demand system information block cell deployments in accordance with one or more aspects of the present disclosure. The operations of the method 1000 may be implemented by a UE or its components as described herein. For example, the operations of the method 1000 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1005, the method may include receiving, via a first cell, control signaling indicative of whether a set of one or more second cells configured for on-demand system information block transmissions is to be evaluated by the UE in association with a cell-reselection procedure, and where the control signaling is indicative of a first set of mobility parameters to be used for the cell-reselection procedure. The operations of 1005 may be performed in accordance with examples as disclosed herein. In some examples, aspects of the operations of 1005 may be performed by a control signaling interface 625 as described with reference to FIG. 6.

At 1010, the method may include performing the cell-reselection procedure associated with a second cell of the set of one or more second cells, or a third cell configured for periodic system information block transmissions in accordance with the control signaling. The operations of 1010 may be performed in accordance with examples as disclosed herein. In some examples, aspects of the operations of 1010 may be performed by a cell-reselection component 630 as described with reference to FIG. 6.

At 1015, the method may include evaluating for the cell-reselection procedure, in accordance with the set of one or more second cells configured for the on-demand system information block transmissions being available for the cell-reselection procedure and using the first set of mobility parameters, the set of one or more second cells configured for the on-demand system information block transmissions. The operations of 1015 may be performed in accordance with examples as disclosed herein. In some examples, aspects of the operations of 1015 may be performed by an on-demand SIB1 cell evaluation component 640 as described with reference to FIG. 6.

The following provides an overview of aspects of the present disclosure:

Aspect 1: A method for wireless communications at a UE, comprising: receiving, via a first cell, control signaling indicative of whether a set of one or more second cells configured for on-demand system information block transmissions is to be evaluated by the UE in association with a cell-reselection procedure; and performing the cell reselection procedure associated with a second cell of the set of one or more second cells, or a third cell configured for periodic system information block transmissions in accordance with the control signaling.

Aspect 2: The method of aspect 1, wherein the control signaling comprises one or more indications that the set of one or more second cells configured for the on-demand system information block transmissions is unavailable for the cell-reselection procedure.

Aspect 3: The method of aspect 2, wherein the one or more indications comprise an invalid value for one or more parameters, the invalid value is indicative of the set of one or more second cells being unavailable.

Aspect 4: The method of aspect 2, wherein the one or more indications comprise an excluded cell list that is indicative of the set of one or more second cells being unavailable for the cell-reselection procedure.

Aspect 5: The method of any of aspects 1 through 4, wherein the control signaling is indicative of a set of mobility parameters to be used for the cell-reselection procedure, the method further comprising: evaluating, in accordance with the set of one or more second cells configured for the on-demand system information block transmissions being unavailable for the cell-reselection procedure and using the set of mobility parameters, the first cell or the third cell configured for the periodic system information block transmissions.

Aspect 6: The method of aspect 1, wherein the control signaling comprises one or more indications that the set of one or more second cells configured for the on-demand system information block transmissions is available for the cell-reselection procedure.

Aspect 7: The method of aspect 6, wherein the one or more indications comprise an excluded cell list that is indicative of the set of one or more second cells being available for the cell-reselection procedure.

Aspect 8: The method of aspect 7, wherein the set of one or more second cells in in the excluded cell list are indicated as being available in accordance with a flag value associated with the excluded cell list.

Aspect 9: The method of aspect 6, wherein the one or more indications comprise an on-demand system information block type 1 (SIB1) cell list comprising the set of one or more second cells configured for the on-demand system information block transmissions.

Aspect 10: The method of any of aspects 6 through 9, wherein the control signaling is indicative of a first set of mobility parameters to be used for the cell-reselection procedure, the method further comprising: evaluating for the cell-reselection procedure, in accordance with the set of one or more second cells configured for the on-demand system information block transmissions being available for the cell-reselection procedure and using the first set of mobility parameters, the set of one or more second cells configured for the on-demand system information block transmissions.

Aspect 11: The method of any of aspects 6 through 9, wherein the control signaling is indicative of a first set of mobility parameters to be used for the cell-reselection procedure, the method further comprising: evaluating, for the cell-reselection procedure and using the first set of mobility parameters, the first cell, one or more second cells of the set of one or more second cells configured for the on-demand system information block transmissions, the third cell configured for the periodic system information block transmissions, or any combination thereof.

Aspect 12: The method of any of aspects 6 through 9, wherein the control signaling is indicative of a first set of mobility parameters to be used in evaluating the set of one or more second cells in association with the cell-reselection procedure and a second set of mobility parameters to be used in evaluating the third cell in association with the cell-reselection procedure.

Aspect 13: The method of aspect 12, wherein performing the cell reselection procedure in accordance with the control signaling comprises: evaluating for the cell-reselection procedure, using the first set of mobility parameters, one or more second cells of the set of one or more second cells configured for the on-demand system information block transmissions; and evaluating for the cell-reselection procedure, using the second set of mobility parameters, the third cell configured for the periodic system information block transmissions.

Aspect 14: The method of any of aspects 12 through 13, wherein the first set of mobility parameters to be used in evaluating the set of one or more second cells comprises a first priority for a second cell of the set of one or more second cells, one or more first thresholds for the cell-reselection procedure, or a first combination thereof; and the second set of mobility parameters to be used in evaluating the third cell comprises a second priority for the third cell, one or more second thresholds for the cell-reselection procedure, or a second combination thereof.

Aspect 15: The method of any of aspects 1 through 14, further comprising: identifying, using a first synchronization raster associated with cells configured for the periodic system information block transmissions, one or more cells including the third cell configured for the periodic system information block transmissions; and identifying, using a second synchronization raster associated with cells configured for the on-demand system information block transmissions, the set of one or more second cells configured for the on-demand system information block transmissions.

Aspect 16: The method of any of aspects 1 through 15, wherein the first cell is configured for the on-demand system information block transmissions.

Aspect 17: The method of any of aspects 1 through 16, wherein the first cell is an anchor cell for the set of one or more second cells, the third cell, or any combination thereof.

Aspect 18: A UE for wireless communications, comprising one or more memories storing processor-executable code, and one or more processors coupled with the one or more memories and individually or collectively operable to execute the code to cause the UE to perform a method of any of aspects 1 through 17.

Aspect 19: A UE for wireless communications, comprising at least one means for performing a method of any of aspects 1 through 17.

Aspect 20: A non-transitory computer-readable medium storing code for wireless communications, the code comprising instructions executable by one or more processors to perform a method of any of aspects 1 through 17.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Also, as used herein, the phrase “a set” shall be construed as including the possibility of a set with one member. That is, the phrase “a set” shall be construed in the same manner as “one or more.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, via a first cell, control signaling indicative of whether a set of one or more second cells configured for on-demand system information block transmissions is to be evaluated by the UE in association with a cell-reselection procedure; and
perform the cell-reselection procedure associated with a second cell of the set of one or more second cells, or a third cell configured for periodic system information block transmissions in accordance with the control signaling.

2. The UE of claim 1, wherein the control signaling comprises one or more indications that the set of one or more second cells configured for the on-demand system information block transmissions is unavailable for the cell-reselection procedure.

3. The UE of claim 2, wherein the one or more indications comprise an invalid value for one or more parameters, the invalid value being indicative of the set of one or more second cells being unavailable.

4. The UE of claim 2, wherein the one or more indications comprise an excluded cell list that is indicative of the set of one or more second cells being unavailable for the cell-reselection procedure.

5. The UE of claim 1, wherein the control signaling is indicative of a set of mobility parameters to be used for the cell-reselection procedure, and wherein the one or more processors are individually or collectively further operable to execute the code to cause the UE to:
evaluate, in accordance with the set of one or more second cells configured for the on-demand system information block transmissions being unavailable for the cell-reselection procedure and using the set of mobility parameters, the first cell or the third cell configured for the periodic system information block transmissions.

6. The UE of claim 1, wherein the control signaling comprises one or more indications that the set of one or more second cells configured for the on-demand system information block transmissions is available for the cell-reselection procedure.

7. The UE of claim 6, wherein the one or more indications comprise an excluded cell list that is indicative of the set of one or more second cells being available for the cell-reselection procedure.

8. The UE of claim 7, wherein the set of one or more second cells in in the excluded cell list are indicated as being available in accordance with a flag value associated with the excluded cell list.

9. The UE of claim 6, wherein the one or more indications comprise an on-demand system information block type 1 (SIB1) cell list comprising the set of one or more second cells configured for the on-demand system information block transmissions.

10. The UE of claim 1, wherein the control signaling is indicative of a first set of mobility parameters to be used for the cell-reselection procedure, and wherein the one or more processors are individually or collectively further operable to execute the code to cause the UE to:
evaluate for the cell-reselection procedure, in accordance with the set of one or more second cells configured for the on-demand system information block transmissions being available for the cell-reselection procedure and using the first set of mobility parameters, the set of one or more second cells configured for the on-demand system information block transmissions.

11. The UE of claim 1, wherein the control signaling is indicative of a first set of mobility parameters to be used for the cell-reselection procedure, and wherein the one or more processors are individually or collectively further operable to execute the code to cause the UE to:
evaluate, for the cell-reselection procedure and using the first set of mobility parameters, the first cell, one or more second cells of the set of one or more second cells configured for the on-demand system information block transmissions, the third cell configured for the periodic system information block transmissions, or any combination thereof.

12. The UE of claim 1, wherein the control signaling is indicative of a first set of mobility parameters to be used in evaluating the set of one or more second cells in association with the cell-reselection procedure and a second set of mobility parameters to be used in evaluating the third cell in association with the cell-reselection procedure.

13. The UE of claim 12, wherein, to perform the cell-reselection procedure in accordance with the control signaling, the one or more processors are individually or collectively operable to execute the code to cause the UE to:
evaluate for the cell-reselection procedure, using the first set of mobility parameters, one or more second cells of the set of one or more second cells configured for the on-demand system information block transmissions; and
evaluate for the cell-reselection procedure, using the second set of mobility parameters, the third cell configured for the periodic system information block transmissions.

14. The UE of claim 12, wherein:
the first set of mobility parameters to be used in evaluating the set of one or more second cells comprises a first priority for a second cell of the set of one or more second cells, one or more first thresholds for the cell-reselection procedure, or a first combination thereof; and
the second set of mobility parameters to be used in evaluating the third cell comprises a second priority for the third cell, one or more second thresholds for the cell-reselection procedure, or a second combination thereof.

15. The UE of claim 1, wherein the one or more processors are individually or collectively further operable to execute the code to cause the UE to:
identify, using a first synchronization raster associated with cells configured for the periodic system information block transmissions, one or more cells including the third cell configured for the periodic system information block transmissions; and
identify, using a second synchronization raster associated with cells configured for the on-demand system information block transmissions, the set of one or more second cells configured for the on-demand system information block transmissions.

16. The UE of claim 1, wherein the first cell is configured for the on-demand system information block transmissions.

17. The UE of claim 1, wherein the first cell is an anchor cell for the set of one or more second cells, the third cell, or any combination thereof.

18. A method for wireless communications at a user equipment (UE), comprising:
receiving, via a first cell, control signaling indicative of whether a set of one or more second cells configured for on-demand system information block transmissions is to be evaluated by the UE in association with a cell-reselection procedure; and
performing the cell-reselection procedure associated with a second cell of the set of one or more second cells, or a third cell configured for periodic system information block transmissions in accordance with the control signaling.

19. The method of claim 18, wherein the control signaling comprises one or more indications that the set of one or more second cells configured for the on-demand system information block transmissions is available for the cell-reselection procedure.

20. A non-transitory computer-readable medium storing code for wireless communications, the code comprising instructions executable by one or more processors to:
receive, via a first cell, control signaling indicative of whether a set of one or more second cells configured for on-demand system information block transmissions is to be evaluated by a user equipment (UE) in association with a cell-reselection procedure; and
perform the cell-reselection procedure associated with a second cell of the set of one or more second cells, or a third cell configured for periodic system information block transmissions in accordance with the control signaling.
